(19) United States
(12) Patent Application Publication
(10) Pub. No.: US 2025/0202285 A1
(43) Pub. Date: Jun. 19, 2025

(54) Wirelessly Powered Remote Switch

(71) Applicant: WiTricity Corporation, Midway, GA (US)

(72) Inventor: Kylee Devro Sealy, Providence, UT (US)

(73) Assignee: WiTricity Corporation, Midway, GA (US)

(21) Appl. No.: 19/069,891

(22) Filed: Mar. 4, 2025

Related U.S. Application Data
(63) Continuation of application No. PCT/US2023/072650, filed on Aug. 22, 2023.
(60) Provisional application No. 63/376,015, filed on Sep. 16, 2022.

(51) Int. Cl. H02J 50/12

(52) U.S. Cl. CPC H02J 50/12

(57) ABSTRACT

Techniques for a wirelessly powered remote switch are disclosed. A power-receive unit receives wireless power when coupled to a power-transmit unit via a magnetic field. The power-receive unit includes one or more input mechanisms that, when actuated, close a switch to enable electric current to flow through an electrical component and a timer. Closing the switch causes an impedance shift at a coil of the power-receive unit based on an impedance of the electrical component according to a frequency defined by the timer. The frequency is detectable by the power-transmit unit to trigger a function.

### CROSS-REFERENCE TO RELATED APPLICATIONS

This application is a bypass continuation of and claims priority to International Patent Application Serial No. PCT/US2023/072650, filed on Aug. 22, 2023, which in turn claims the benefit of U.S. Provisional Patent Application Ser. No. 63/376,015 filed on Sep. 16, 2022, the disclosures of which are incorporated by reference herein in their entireties.

### FIELD

This application is generally related to wireless charging power transfer applications, and specifically to a low-cost method and apparatus for wirelessly powering a remote switch and detecting which buttons are activated on the remote switch.

### BACKGROUND

Generally, wireless power transfer (WPT) systems include communication between a power-transmit unit (PTU) and a power-receive unit (PRU). For example, the PTU and PRU in many WPT systems communicate via Bluetooth LE, Wi-Fi, or near-field communication (NFC). In some WPT systems, communication occurs in-band using traditional modulation and encoding techniques.

When communication occurs via out-of-band means, a pairing is required to ensure the PTU is communicating with the same PRU that the PTU is powering. This pairing requires additional steps and methods of coordination between the PTU and PRU. When communication occurs via in-band means, the PRU typically first performs load modulation with traditional methods (e.g., On-Off Keying (OOK), Amplitude Shift Keying (ASK), Frequency Shift Keying (FSK), Phase Shift Keying (PSK)) and then performs additional encoding (e.g., Manchester (or phase encoding), Return-to-Zero (RZ), Non-Return-to-Zero (NRZ), Bi-Phase, Block). However, such pairing procedures and modulation and encoding techniques may not be suitable for simplistic scenarios that utilize low-cost or disposable remote buttons or switches, such as a low-cost and simple method of wirelessly powering a remote switch and merely detecting which buttons are pressed.

### SUMMARY

Techniques for a wirelessly powered remote switch are disclosed. A PRU receives wireless power when coupled to a PTU via a magnetic field. The PRU includes one or more input mechanisms that, when actuated, close a switch to enable electric current to flow through an electrical component and a timer. Closing the switch causes an impedance shift at an inductive coil of the PRU based on an impedance of the electrical component according to a frequency defined by the timer. The frequency is detectable by the PTU to trigger a function associated with the input mechanism.

One aspect of the disclosure provides a wirelessly powered remote switch comprising a PRU and an input mechanism. The PRU is configured to receive wireless power when coupled to a PTU via a magnetic field. The PRU includes a coil, an electrical component, a timer, and an electrical switch. The coil is configured to generate an electric current when exposed to the magnetic field. The electrical component provides an impedance when a voltage or the electric current is applied to the electrical component. The timer is configured to define one or more frequencies for the electrical component. The electrical switch connects the electrical component to the timer. The input mechanism is connected to the electrical switch and configured, when actuated, to close the electrical switch to enable the electric current to flow through both the electrical component and the timer and cause an impedance shift at the coil based on the impedance of the electrical component according to the one or more frequencies defined by the timer. In implementations, the one or more frequencies are detectable by the PTU to trigger a function.

Another aspect of the disclosure provides a method. The method includes detecting a localized field disturbance in a magnetic field generated by a PTU of a WPT system that is coupled to a PRU of the WPT system for transferring power from the PTU to the PRU. The method also includes measuring one or more frequency components associated with the localized field disturbance and determining, based on the one or more frequency components, that at least one input mechanism has been actuated at the PRU. Further, the method includes initiating, by the PTU, a function associated with actuation of the at least one input mechanism at the PRU.

Various implementations of systems, methods, and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in accompanying drawings and the descriptions below. Other features, aspects, and advantages will become apparent from the description, the drawings, and the claims.

### BRIEF DESCRIPTION OF THE DRAWINGS

FIG. 1 is a functional block diagram of an example wireless power transfer system, in accordance with certain aspects of the present disclosure.

FIG. 2 is a more-detailed block diagram of an example wireless power transfer system, in accordance with aspects of the present disclosure.

FIG. 3 is a schematic diagram of a portion of the transmit circuitry or the receive circuitry of FIG. 2, in accordance with certain aspects of the present disclosure.

FIG. 4 illustrates a schematic diagram of electrical elements usable for implementing a wirelessly powered remote switch.

FIG. 5 illustrates an example implementation of a wirelessly powered remote switch.

FIG. 6 depicts an example method for a wirelessly powered remote switch in a WPT system.

### DETAILED DESCRIPTION

As mentioned above, for a PTU and a PRU to communicate and coordinate with one another, many conventional WPT systems use modulation and encoding techniques or require pairing between the PRU and the PTU. However, such pairing procedures and modulation and encoding techniques may not be suitable for simplistic scenarios that utilize low-cost or disposable remote buttons or switches, such as a low-cost and simple method of wirelessly powering a remote switch and merely detecting which buttons are pressed.

Techniques for a wirelessly powered remote switch are disclosed herein. In aspects, a remote switch having a PRU is wirelessly powered by a PTU. The PTU can detect an impedance shift caused by a button press at the PRU and determine which button or combination of buttons was pressed at the PRU based on frequency-domain characteristics associated with the impedance shift. For example, different impedance shifts occur at different designated frequencies. In this way, the PRU uses frequency encoding to enable the PTU to identify which button is pressed. Further, the wirelessly powered remote switch described herein can be implemented using existing low-cost components rather than customized parts that may increase manufacturing costs.

The detailed description set forth below in connection with the appended drawings is intended as a description of example implementations and is not intended to represent the only implementations in which the techniques described herein may be practiced. The term “example” used throughout this description means “serving as an example, instance, or illustration,” and should not necessarily be construed as preferred or advantageous over other example implementations. The detailed description includes specific details for the purpose of providing a thorough understanding of the example implementations. In some instances, some devices are shown in block diagram form. Drawing elements that are common among the following figures may be identified using the same reference numerals.

### Example Systems

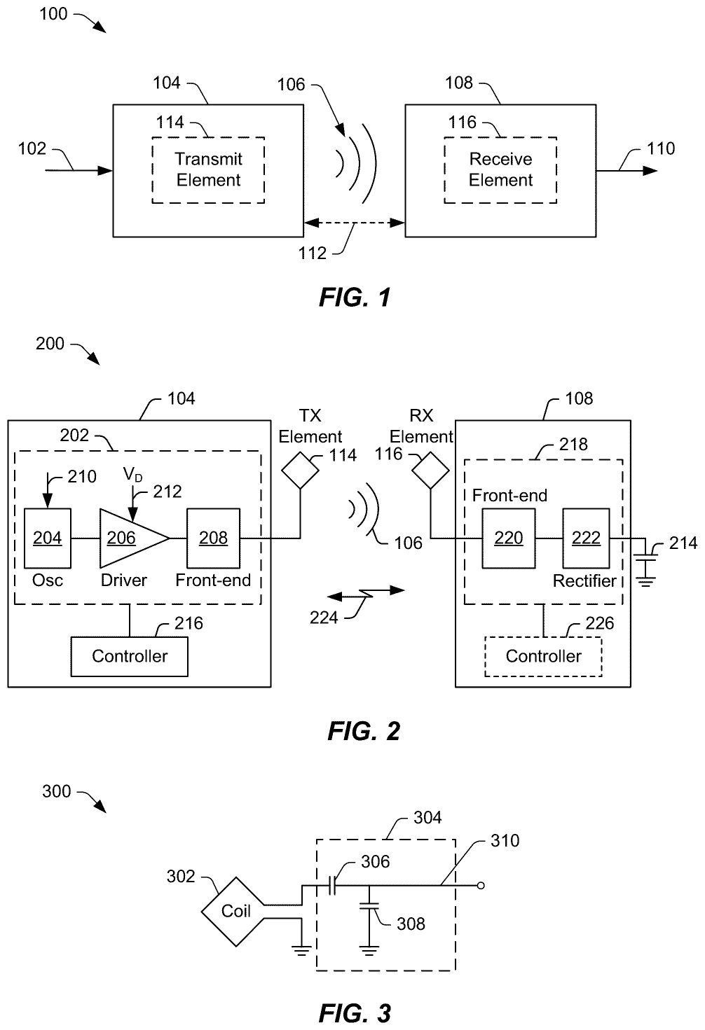

FIG. 1 is a functional block diagram of an example wireless power transfer system 100, in accordance with certain aspects of the present disclosure. Input power 102 may be provided to a transmitter 104 from a power source (not shown in this figure) to generate a wireless (e.g., magnetic or electromagnetic) field 106 for performing energy transfer. A receiver 108 may be subjected to the wireless field 106 and generate output power 110 for storing or consumption by a device (e.g., a battery) coupled to the output power 110. The transmitter 104 and the receiver 108 may be separated by a distance 112. The transmitter 104 may include a power transmitting element 114 for transmitting/providing energy to the receiver 108. The receiver 108 may include a power receiving element 116 for receiving/capturing energy transmitted from the transmitter 104.

In one illustrative aspect, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for increased efficiency and power transfer over various distances and with a variety of inductive power transmitting and receiving element configurations.

In some aspects, the wireless field 106 may correspond to a “near field” of the transmitter 104. The near field may correspond to a region in which there are strong reactive fields resulting from the currents and charges in the power transmitting element 114 that minimally radiate power away from the power transmitting element 114. The near field may correspond to a region that is within about one wavelength (or a fraction thereof, e.g., one wavelength divided by 2π) of the power transmitting element 114. Conversely, a far field may correspond to a region that is greater than about one wavelength (or a fraction thereof, e.g., one wavelength divided by 2π) of the power transmitting element 114.

In aspects, efficient energy transfer may occur by coupling a large portion of the energy in the wireless field 106 to the power receiving element 116, rather than propagating most of the energy in an electromagnetic wave to the far field.

In some implementations, the transmitter 104 may output a time-varying magnetic (or electromagnetic) field with a frequency corresponding to the resonant frequency of the power transmitting element 114. When the receiver 108 is within the wireless field 106, the time-varying magnetic (or electromagnetic) field may induce a current in the power receiving element 116. As described above, if the power receiving element 116 is configured as a resonant circuit to resonate at (or very close to) the frequency of the power transmitting element 114, energy may be efficiently transferred. An alternating current (AC) signal induced in the power receiving element 116 may be rectified to produce a direct current (DC) signal that may be provided to charge or to power a load (e.g., a battery).

FIG. 2 is a more-detailed block diagram of an example wireless power transfer system 200, in accordance with aspects of the present disclosure. The system 200 may include the transmitter 104 and the receiver 108. The transmitter 104 (also referred to herein as a power-transmit unit, or PTU) includes transmit circuitry 202 that may include an oscillator 204, a driver circuit 206, and a front-end circuit 208. The oscillator 204 may be configured to generate an oscillator signal (also known as an oscillating signal) at a desired frequency (e.g., fundamental frequency), which may be adjusted in response to a frequency control signal 210. The oscillator 204 may provide the oscillator signal to the driver circuit 206. The driver circuit 206 may be configured to drive the power transmitting element 114 at, for example, a resonant frequency of the power transmitting element 114, according to the frequency of the oscillator signal. The power transmitting element 114 may be powered by a power supply signal (V_{D}) 212. The driver circuit 206 may be a switching amplifier configured to receive a square wave from the oscillator 204 and output a sine wave as a driving signal output.

The front-end circuit 208 may include a filter circuit configured to filter out harmonics or other unwanted frequencies. The front-end circuit 208 may also include a matching circuit configured to match the impedance of the transmitter 104 to the impedance of the power transmitting element 114 in an effort to reduce power loss. As explained in more detail below, the front-end circuit 208 may include a tuning circuit to create a resonant circuit with the power transmitting element 114. As a result of driving the power transmitting element 114, the power transmitting element 114 may generate the wireless field 106 to wirelessly output power at a level sufficient for charging a battery 214, or otherwise powering a load.

The transmitter 104 may further include a controller 216 operably coupled to the transmit circuitry 202 and configured to control one or more aspects of the transmit circuitry 202, or accomplish other operations relevant to managing the transfer of power. The controller 216 may be a microcontroller or a processor, for example. In some aspects, the controller 216 may be implemented as an application-specific integrated circuit (ASIC). The controller 216 may be operably connected, directly or indirectly, to each component of the transmit circuitry 202. The controller 216 may be further configured to receive information from each of the components of the transmit circuitry 202 and perform calculations based on the received information. The controller 216 may be configured to generate control signals (e.g., signal 210) for each of the components that may adjust the operation of that component. As such, the controller 216 may be configured to adjust or manage the power transfer based on a result of the operations performed by it. The transmitter 104 may further include a memory (not shown) configured to store data, such as instructions for causing the controller 216 to perform particular functions, such as those related to management of wireless power transfer.

The receiver 108 (also referred to herein as a power-receive unit, or PRU) includes receive circuitry 218 that may include a front-end circuit 220 and a rectifier circuit 222. The front-end circuit 220 may include matching circuitry configured to match the impedance of the receive circuitry 218 to the impedance of the power receiving element 116 in an effort to reduce power loss. As will be explained below, the front-end circuit 220 may further include a tuning circuit to create a resonant circuit with the power receiving element 116. The rectifier circuit 222 may generate a DC power output from an AC power input to charge the battery 214, as shown in FIG. 2, or power a load. The receiver 108 and the transmitter 104 may additionally communicate on a separate communication channel 224 using any suitable radio access technology (e.g., Bluetooth, Zigbee, cellular, etc.). The receiver 108 and the transmitter 104 may alternatively communicate via in-band signaling using characteristics of the wireless field 106.

The receiver 108 may be configured to determine whether an amount of power transmitted by the transmitter 104 and received by the receiver 108 is appropriate for charging the battery 214. In some aspects, the transmitter 104 may be configured to generate a predominantly non-radiative field with a direct field coupling coefficient (k) for providing energy transfer. Receiver 108 may directly couple to the wireless field 106 and may generate an output power for storing or consumption by a battery 214 (or load) coupled to the output or receive circuitry 218.

The receiver 108 may further include a controller 226 configured similarly to the transmit controller 216 as described above for managing one or more aspects of the receiver 108. The receiver 108 may further include a memory (not shown) configured to store data, such as instructions for causing the controller 226 to perform particular functions, such as those related to management of wireless power transfer.

As discussed above, the transmitter 104 and the receiver 108 may be separated by a distance and may be configured according to a mutual resonant relationship to minimize transmission losses between the transmitter 104 and the receiver 108.

FIG. 3 is a schematic diagram of a portion of the transmit circuitry 202 or the receive circuitry 218 of FIG. 2, in accordance with certain aspects of the present disclosure. As illustrated in FIG. 3, transmit or receive circuitry 300 may include a power transmitting or receiving element 302 and a tuning circuit 304. The power transmitting or receiving element 302 may also be referred to or be configured as an antenna or a “loop” antenna. The term “antenna” generally refers to a component that may wirelessly output or receive energy for coupling to another antenna. The power transmitting or receiving element 302 may also be referred to herein or be configured as a “magnetic” antenna, an induction coil, an inductive coil, a resonator, or a portion of a resonator. The power transmitting or receiving element 302 may also be referred to as a coil or resonator of a type that is configured to wirelessly output or receive power. As used herein, the power transmitting or receiving element 302 is an example of a “power transfer component” of a type that is configured to wirelessly output and/or receive power. The power transmitting or receiving element 302 may include an air core or a physical core such as a ferrite core (not shown FIG. 3).

When the power transmitting or receiving element 302 is configured as a resonant circuit or resonator with tuning circuit 304, the resonant frequency of the power transmitting or receiving element 302 may be based on the inductance and capacitance. Inductance may be simply the inductance created by a coil and/or other inductor forming the power transmitting or receiving element 302. Capacitance (e.g., a capacitor) may be provided by the tuning circuit 304 to create a resonant structure at a desired resonant frequency. As a non-limiting example, the tuning circuit 304 may comprise a capacitor 306 and a capacitor 308, which may be added to the transmit and/or receive circuitry 300 to create a resonant circuit.

The tuning circuit 304 may include other components to form a resonant circuit with the power transmitting or receiving element 302. As another non-limiting example, the tuning circuit 304 may include a capacitor (not shown) placed in parallel between the two terminals of the circuitry 300. Still other designs are possible. In some aspects, the tuning circuit in the front-end circuit 208 of the transmitter 104 may have the same design (e.g., 304) as the tuning circuit in front-end circuit 220 of the receiver 108. In other aspects, the front-end circuit 208 of the transmitter 104 may use a tuning circuit design different from the front-end circuit 220 of the receiver 108.

For power transmitting elements, a signal 310, with a frequency that substantially corresponds to the resonant frequency of the power transmitting or receiving element 302, may be an input to the power transmitting or receiving element 302. For power receiving elements, the signal 310, with a frequency that substantially corresponds to the resonant frequency of the power transmitting or receiving element 302, may be an output from the power transmitting or receiving element 302. Although aspects disclosed herein may be generally directed to resonant wireless power transfer, persons of ordinary skill in the art will appreciate that aspects disclosed herein may be used in non-resonant implementations for wireless power transfer.

In some aspects, when power is wirelessly received by a device (e.g., an electric vehicle, a remote switch) with a wireless power receiver (e.g., receiver 108) from a wireless power transmitter (e.g., transmitter 104), there may be a method of power control to ensure that the correct amount of power is transferred from the transmitter 104 to the receiver 108. For example, the device with the receiver 108 may be configured to operate or charge at a particular voltage (e.g., 4.2 V). However, generating a fixed strength wireless field (e.g., wireless field 106) by the transmitter 104 may not produce the desired voltage at the receiver 108. For example, the amount of power transferred between the transmitter 104 and the receiver 108 at any given strength of the wireless field 106 may differ based on the distance between (and/or other factors such as materials between, etc.) the transmitter 104 and the receiver 108. Accordingly, the power generated by the receiver 108 for the device may be variable based on one or more factors for the same strength of wireless field 106 from the transmitter 104.

In some aspects, a closed-loop power control scheme may be employed to adjust the strength of the wireless field 106 to ensure that the power (e.g., voltage) at the device being wirelessly powered is the desired power (e.g., desired voltage). For example, in some aspects, the receiver 108 may be configured to actively determine a power level of the power received at the receiver 108, such as, a voltage at the rectifier circuit 222. For example, the controller 226 may be configured to monitor the voltage at the rectifier circuit 222. Depending on whether the voltage at the rectifier circuit 222 is above or below a range of the desired voltage level, the receiver 108 (e.g., as controlled by the controller 226) may transmit feedback information (e.g., as a control signal) (e.g., via communication channel 224 or in-band signaling using the wireless field 106) to the transmitter 104 indicating whether a strength of the wireless field 106 should be increased or decreased. No control signal may be sent if the voltage at the rectifier circuit 222 is within the range of the desired voltage level. The transmitter 104 may receive the control signal and adjust the strength of the wireless field 106 (e.g., by control from the controller 216), accordingly.

The techniques described herein may be implemented in a variety of different wireless power transfer systems including, for example, a wirelessly powered remote switch. Some examples include, but are not limited to, a wirelessly powered remote switch on a seat cover, a pillow case, a wearable item (e.g., clothing, wristwatch, glove, shoe), a blanket, a mat (e.g., floormat, desktop mat), a picture frame, a business card, a gift card, a key cover, etc. Because the wirelessly powered remoted switch can be implemented with low-cost materials and components, the wireless powered remote switch may be implemented on a disposable item, which can be replaced and/or reproduced at low cost.

### Example Implementations

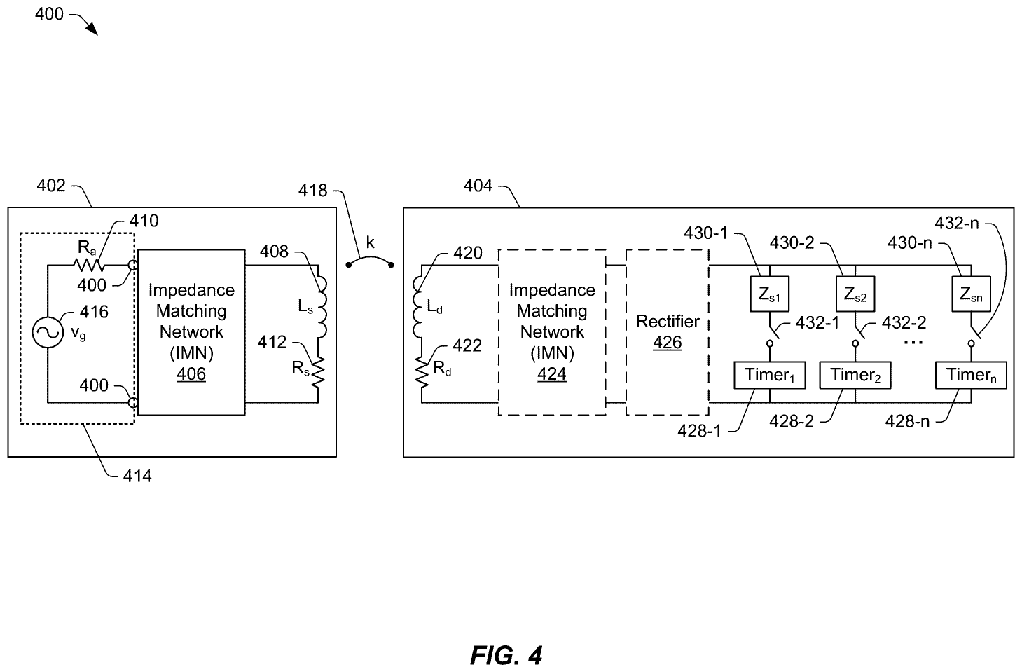

FIG. 4 illustrates a schematic diagram 400 of electrical elements usable for implementing a wirelessly powered remote switch. The illustrated example includes a simplified equivalent of a power-transmit unit (PTU) 402 (e.g., transmitter 104) and a simplified equivalent of a power-receive unit (PRU) 404 (e.g., receiver 108). The PRU 404 is remote (e.g., not physically connected) from the PTU 402 and configured to be wirelessly powered by the PTU 402. The PRU 404 can be implemented as a remote switch having input mechanisms (e.g., buttons) that are usable by a user to initiate or trigger one or more functions or operations at the PTU 402. As is described in detail herein, the PTU 402 can determine which button is pressed at the PRU 404 by detecting frequency components in an impedance change in the PTU's transmit coil.

The PTU 402 includes at least an impedance matching network (IMN) 406, and a power transmitting element (e.g., inductor Lₛ 408). The inductor Lₛ 408 is an example implementation of the transmitting element 302 (e.g., coil) at the PTU 402. Accordingly, the inductor Lₛ 408 may be referred to as an inductive coil. The PTU 402 may also include one or more resistors (e.g., resistor Rₐ 410, resistor Rₛ 412), any of which may be in series or in parallel with the inductor Lₛ 408. The IMN 406 is configured to match the impedance of the PTU 402 to the impedance of the power transmitting element (e.g., the inductor Lₛ 408) to reduce power loss. Connected to the IMN 406 is an amplifier 414 (e.g., PTU's power converter, front-end circuit 208), which is illustrated as a simplified equivalent of an amplifier circuit. The amplifier 414 is connected to the IMN 406 and provides input to the IMN 406.

Measurement features (not shown in FIG. 4) can be incorporated at various locations at the PTU 402 to perform one or more measurement techniques. The measurement features can be implemented to measure fundamental and harmonic components of the output voltage and current of a high-frequency inverter.

In aspects, an AC power source 416 (e.g., voltage source) supplies AC power to the IMN 406 via the amplifier 414. The IMN 406 converts the incoming AC power to a power signal running at a system voltage and frequency to drive the inductor Lₛ 408 to generate a magnetic field (e.g., wireless field 106) for coupling with the PRU 404 (e.g., via coupling k 418). In some implementations, the magnetic field is constant (e.g., the current does not change across an inductor L_{d} 420 and a resistor R_{d} 422. In some implementations, the magnetic field may change along with the impedance changes. Depending on the specific application, different behaviors can be detected, which can be tailored based on the configuration of the impedance matching networks.

The PRU 404 includes at least a power receiving element (e.g., inductor L_{d} 420) and one or more resistors (e.g., resistor R_{d} 422), which may be in series or in parallel with the inductor L_{d} 420. The inductor L_{d} 420 is an example implementation of the receiving element 302 (e.g., coil) at the PRU 404. Accordingly, the inductor L_{d} 420 may be referred to as an inductive coil. The PRU 404 optionally includes an impedance matching network (IMN) 424, which is configured to match the impedance of the circuitry of the PRU 404 to the impedance of the power receiving element (e.g., inductor L_{d} 420) in an effort to reduce power loss. The PRU 404 may also optionally include an AC to DC converter (e.g., rectifier 426) to convert the AC current signal, generated by the inductor L_{d} 420 when exposed to the magnetic field, to a DC current signal.

The PRU 404 also includes a plurality of timers 428 (e.g., timer₁ 428-1, timer₂ 428-2, . . . , timerₙ 428-n) electrically connected to a plurality of electrical components 430 (e.g., Zₛ₁ 430-1, Zₛ₂ 430-2, . . . , Zₛₙ 430-n) via electrical switches 432 (e.g., electrical switch 432-1, electrical switch 432-2, . . . , electrical switch 432-n). As mentioned, the IMN 424 is configured to match the impedance of the circuitry of the PRU 404, which includes at least the electrical component(s) 430. In some implementations, the IMN 424 matches the impedance of the electrical components 430 and the timers 428. In an example implementation, each of the electrical components 430 includes local rectification and a timer, which may enable the PRU 404 to operate without the rectifier 426. In another example implementation, each of the electrical components 430 includes a filter and a rectifier, which may enable the PRU 404 to operate without the rectifier 426. Accordingly, a variety of implementations exist in which the PRU 404 can use the energy generated by the inductor L_{d} 420 when exposed to the magnetic field.

The electrical components 430 are illustrated as a generalization of electrical components that are usable in the circuit and that have some impedance Z. A DC voltage, for instance, applied as input to the electrical components 430 provides an impedance Z in each of the electrical components 430. The impedance in the electrical components 430 may be constant or changing. In a very simple example, the electrical component 430 (e.g., electrical component 430-1) may be a load that draws either constant power or has a constant resistance (e.g., a constant power load may provide a strong signal that is detectable by the PTU 402). In another example, the electrical component 430 (e.g., electrical component 430-1) may be a capacitor or an inductor, which changes impedance responsive to a phase-shifted load. In another example, the electrical component 430 may be a short. A short condition (with or without a rectifier) that shorts the coil (e.g., inductor L_{d} 420), for example, may provide an impedance change that can be sensed by the PTU 402 in various ways. Accordingly, the electrical components 430 illustrated in FIG. 4 represent various types of electrical components having an impedance.

In an example, at least one (including all) of the timers 428 is an AC-powered timer. In another example, at least one (including all) of the timers 428 is a DC-powered timer. In some implementations, at least one (including all) of the timers 428 is an analog circuit. In some implementations, at least one (including all) of the timers 428 is a digital circuit. In one example, at least one (including all) of the timers 428 is filtered. In another example, at least one (including all) of the timers 428 is unfiltered (e.g., producing square-like waveforms) or is filtered (e.g., producing more sinusoidal waveforms). Some of the timers 428 may have different frequency-domain characteristics with respect to the fundamental frequency and harmonics. Further example timers include a 555 timer or an analog oscillator, which are both well known in the industry. Accordingly, the timer(s) 428 may be any suitable timer.

The impedance shifts in the electrical components 430 may be timed to occur at a designated frequency. Accordingly, the frequency at which the impedance shifts occur is detected. In aspects, the power shift and the phase shift may also be detected.

In implementations, the electrical switches 432 represent input mechanisms (e.g., buttons) on a controller that are usable by a user. Depending on the number of electrical switches 432 used in the circuit, two or more of the electrical components 430 may have different impedances or the same impedance. In one example, two or more of the electrical components 430 may have the same impedance at different frequencies to indicate or correspond to different buttons. In another example, each button may have an impedance (e.g., electrical component 430) and a timer 428. Accordingly, there are various arrangements for the circuit to implement the circuit described herein, many of which are described herein but are not intended to be limiting examples. A different frequency can correspond to each button on the remote switch and each of those frequencies may be individually detectable, for example, using Fourier analysis (e.g., a Fast-Fourier Transform (FFT) of a current measurement of the inductor Lₛ 408, a power measurement of the amplifier 414, or some current, voltage, or power measurement at the PTU 402. Any suitable variations of the Fourier analysis can be used, examples of which include discrete Fourier Transform (DFT), and so forth. One example variation of FFT may include multiple analog or discrete filters (e.g., infinite impulse response (IIR), finite impulse response (FIR)) used at set frequencies to detect magnitudes at those set frequencies.

The timer 428 generates a signal having a pre-determined frequency. The timer 428 can be used in a variety of applications, including timer applications, delay applications, pulse generation applications, and oscillator applications. In some implementations, the timer 428 is an integrated circuit configured to act as a simple timer by generating pulses or delays. In some implementations, the timer 428 is an integrated circuit configured to to act as a relaxation oscillator by producing a string of stabilized waveforms of varying duty cycles from, e.g., 50% to 100%. In one example, two or more (including all) of the timers 428 can be synchronized to modify signals at the same time, such as generating signals that are in phase with each other. In another example, two or more (including all) of the timers 428 can operate asynchronously (e.g., produce individually occurring signal artifacts). The timers 428 between buttons may or may not be coordinated in phase but the frequency components of the timers 428 are selected to be additive and individually detectable. It may be beneficial in some implementations to coordinate the phase relationship between the timers 428 to control harmonic frequencies, control distortion, and/or reduce the peak power draw. In some implementations, the duty cycle can be changed to reduce peak power conditions. For example, with the duty cycle, the fundamental frequency may be retained but the harmonic frequencies that are generated are different. These differences can be used to create different electromagnetic interference (EMI) profiles.

In some aspects, a single timer 428 may be connected to multiple electrical switches 432 and may include logic based on the switches that sets the frequency. In some implementations, one timer may designate the frequency based on which subset or combination of buttons are pressed (e.g., a frequency per button and another frequency for different button combinations). In some aspects, multiple timers 428 may be combined into a single timer but may produce different frequencies depending on which button is pressed.

When no buttons are depressed on the PRU 404, there is very little, if any, power drawn by the PRU 404 from the PTU 402. Further, the frequencies present when no buttons are depressed are the WPT frequency and possible harmonics of the WPT frequency.

When a button is depressed by an intentional act (e.g., user presses a button on a remote switch), the localized field of the PRU 404 is perturbed by impedance Zₛ at a frequency defined by the timer 428. This localized field disturbance may or may not cause the magnetic field of the PTU 402 to be disturbed (e.g., current in the inductor Lₛ 408 of the PTU 402 may or may not change). However, the localized field disturbance at the PRU 404 is reflected in the coil impedance (Rₛ+jωLₛ) of the PTU 402. The impedance change at the PTU's coil (e.g., inductor Lₛ 408) can be detected by (i) direct impedance measurement techniques at the coil, (ii) indirect impedance measurements at the amplifier 414 (e.g., power measurement), or (iii) indirect impedance measurements at the input to the amplifier 414 (e.g., DC voltage/current measurement). Measurements may include any or all of current magnitude or phase, voltage magnitude or phase, or proximal field magnitude or phase.

The disturbance from the button press occurs in the frequency domain and is distinguishable from other nearby EMI disturbances, power being drawn by a different (or the same) PRU, and so forth. In aspects, each timer 428 has a unique frequency (or frequencies) separated sufficiently from the other timers 428 to enable each button press to be detectable by the PTU 402.

The PTU 402 can perform an FFT on one or more of its sensors to determine the frequency components of the localized field disturbance caused by the PRU 404. In implementations, a low order FFT is effective because the frequencies used in the WPT system are low frequencies (e.g., kHz or Hz). For instance, the number of bins used in the FFT (e.g., order of the FFT) can be low to match the number of buttons on the PRU 404. In some implementations, the number of bins used in the FFT can be higher to ensure sufficient spacing between frequency bins and more robustly distinguish frequencies.

Because a simplified FFT is used by the PTU 402, button detection may be implemented using low-cost microcontrollers or digital signal processors (DSPs). Further, low-cost timers and simple circuitry can be used at the PRU 404. The impedances attached to at least two buttons may be similar to one another. In some implementations, the impedances attached to at least two buttons may be dissimilar to one another. In some further implementations, the impedances attached to at least two buttons may be changing (e.g., sub-modulated) to further enhance detectability by the sensors being used at the PTU 402.

In aspects, the buttons pressed by the user may or may not be the same switches used to activate the timers 428. In some implementations, the timers 428 or electrical switches 432 can be latched for a minimum duration (e.g., predefined duration of time) to ensure detectability by the PTU 402. For example, the timers 428 can hold the frequency operating for a duration of time (e.g., duration greater than one second), which may provide time for the PTU 402 to detect the frequency even if the button is pressed only momentarily.

In addition to the blocks shown in the diagram 400, the PRU 404 may have other load draws without a specific frequency characteristic to handle quiescent operations. Some example operations include activation of light-emitting diodes (LEDs) for visual effects, buzzers or speakers for sound effects, motors or vibrators for tactile effects, and so forth.

Using the techniques described herein, the PRU 404 can be a low-cost device, which is disposable. Some implementations may include multiple PRUs 404 coupled to and being charged by a single PTU 402. In such an implementation, one PRU may have buttons and corresponding frequencies that are different from another PRU. In this way, the PTU 402 can distinguish between the buttons on one PRU as well as the other PRU and its buttons. This ability to distinguish between different buttons on different PRUs 404 is based on the frequency detection rather than using the time domain. However, in some implementations, two or more PRUs may utilize the same frequency or frequencies, which may enable one PRU to override the another PRU.

The PRU 404 is wirelessly powered via the coupling with the PTU 402. In some implementations, the magnetic field provided by the PTU 402 is a constant field (e.g., always-on field). A constant field may be useful to ensure fast and accurate detection of button presses as well as to power auxiliary loads.

In some implementations, the magnetic field is an event-driven field (e.g., field generation is caused by an event). In an example, the PTU 402 provides a lower field (e.g., for less power draw) and increases its magnetic field when the PRU 404 is detected, either by a constant or varied load draw (e.g., load power sensing) or button actuation (e.g., sensed in the frequency domain). In some aspects, the event may be detection of an object, such as when the PTU 402 senses an object based on a weak signal and then increases its field (e.g., increases its detection sensitivity) to increase the strength of the signal to enable an increased power draw by the PRU 404.

In some implementations, the magnetic field is a polled field (e.g., periodically ramped field). In an example, the PTU 402 periodically provides the magnetic field at a predetermined rate and duty cycle (fixed or variable). The rate and duty cycle may be selected to ensure a button press is detectable by the PTU 402. In aspects, the PTU 402 may latch its field or increase its field if a button press is detected or a PRU's power draw is detected. In one example, the magnetic field is polled every, e.g., one second, but a button press may be pressed for a duration that is shorter than the one second. Then, the PRU's timer(s) 428 associated with the pressed button(s) can latch the corresponding frequency for longer than the one second to enable the PTU 402 to detect the frequency over the polled field.

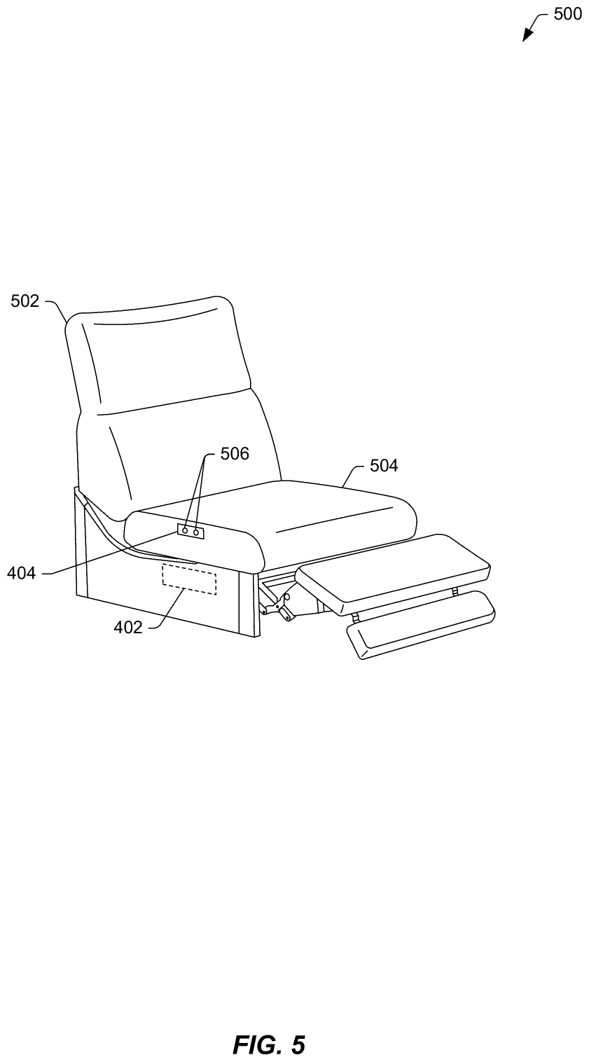

FIG. 5 illustrates an example implementation 500 of a wirelessly powered remote switch. The illustrated example includes a recliner 502, which may be one piece of a sectional sofa. The recliner may include motors, gears, and other mechanical and electrical systems (not illustrated in FIG. 5) for transitioning the recliner 502 between a sitting position and a reclining position. The base of the recliner 502 may include an implementation of the PTU 402. An implementation of the PRU 404 may be disposed on a cover 504 of a cushion (or pillow) of the recliner 502. The PRU 404 may include buttons 506 that a user can press to operate the recliner 502 (e.g., transition between the sitting position and the reclining position). The PTU 402 provides power to the PRU 404 to enable the PRU 404 to act as a wirelessly powered remote switch to operate the recliner 502 based on the PTU 402 detecting a button press (of one of the buttons 506) in the frequency domain.

In one example, the PTU 402 provides a lower field for less power draw such that the PTU 402 does not sense the PRU 404. When a user sits down on the recliner 502, the PTU 402 detects the user through object detection techniques (e.g., foreign object detection, living object detection) and responsively increases its magnetic field k to be able to sense the PRU 404, effectively enabling the buttons 506 to be activated.

Because of the particular architecture of the PRU 404, the cover 504 can be removed from the cushion and washed without damaging the PRU 404. Also, the cover 504 can be easily replaced by the user with a different cover having a second PRU, which can be wirelessly powered by the PTU 402 without requiring a network pairing of the second PRU to the PTU 402. Further, using the measurement techniques described herein in the frequency-domain at the PTU 402, the second PRU can act as a remote switch to operate the recliner 502.

### Example Methods

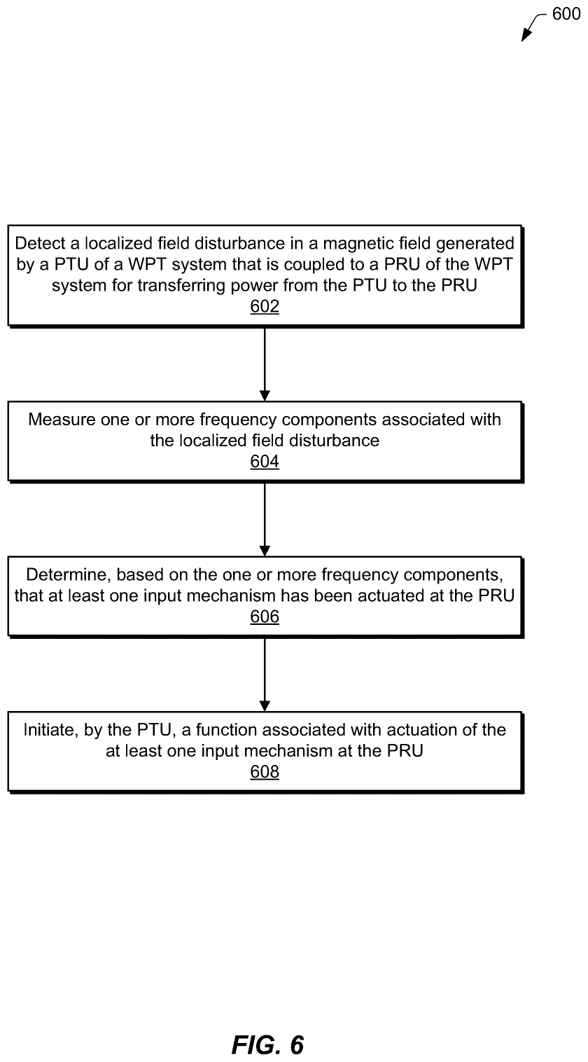

FIG. 6 depicts an example method 600 for a wirelessly powered remote switch in a WPT system. The example procedures may be employed in the implementations and systems described with respect to FIGS. 1-5, and/or any other suitable environment. The steps described for the various procedures can be implemented automatically and independent of user interaction. The orders in which operations of these procedures are shown and/or described are not intended to be construed as a limitation, and any number or combination of the described procedure operations can be combined in any order to implement a method, or an alternate method.

At 602, a localized field disturbance is detected in a magnetic field generated by a PTU of a WPT system that is coupled to a PRU of the WPT system for transferring power from the PTU to the PRU. For example, the PTU 402 detects an impedance shift (e.g., in a power fluctuation, in a phase fluctuation) while transmitting power to the PRU 404.

At 604, the PTU measures one or more frequency components associated with the localized field disturbance. For example, the PTU 402 measures the frequency of the impedance shift by using FFT.

At 606, the PTU determines, based on the one or more frequency components, that at least one input mechanism has been actuated at the PRU. For example, the measured frequency is associated with a particular button, or a combination of buttons, at the PRU. Accordingly, the PTU 402 identifies which button or combination of buttons at the PRU has been actuated.

At 608, the PTU initiates a function associated with actuation of the at least one input mechanism at the PRU. As described in FIG. 5, for example, the PTU can cause the electrical system of the recliner 502 to operate (e.g., to transition the recliner between the sitting position and the reclining position). A first button at the PRU 404, for example, may be associated with a first frequency, which is detectable by the PTU and usable to cause the electrical system of the recliner to transition toward the reclining position. In addition, a second button at the PRU 404 may be associated with a second frequency, which is detectable by the PTU and usable to cause the electrical system of the recliner to transition toward the sitting position.

The various illustrative logical blocks, modules, circuits, and method steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the described aspects.

The various illustrative blocks, modules, and circuits described in connection with the aspects disclosed herein may be implemented or performed with a general purpose hardware processor, a Digital Signal Processor (DSP), an Application-Specific Integrated Circuit (ASIC), a Field Programmable Gate Array (FPGA) or other programmable logic device, discrete gate or transistor logic, discrete hardware components, or any combination thereof designed to perform the functions described herein. A general-purpose hardware processor may be a microprocessor, but in the alternative, the hardware processor may be any conventional processor, controller, microcontroller, or state machine. The hardware processor may also be implemented as a combination of computing devices, e.g., a combination of a DSP and a microprocessor, a plurality of microprocessors, one or more microprocessors in conjunction with a DSP core, or any other such configuration.

The steps of a method and functions described in connection with the aspects disclosed herein may be embodied directly in hardware, in a software module executed by a hardware processor, or in a combination of the two. If implemented in software, the functions may be stored on or transmitted as one or more instructions or code on a tangible, non-transitory, computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the hardware processor such that the hardware processor can read information from, and write information to, the storage medium. In the alternative, the storage medium may be integral to the hardware processor. Disk and disc, as used herein, includes compact disc (CD), laser disc, optical disc, digital versatile disc (DVD), floppy disk and Blu-ray™ disc where disks usually reproduce data magnetically, while discs reproduce data optically with lasers. Combinations of the above should also be included within the scope of computer-readable media. The hardware processor and the storage medium may reside in an ASIC.

Although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. A wirelessly powered remote switch comprising:
a power-receive unit configured to receive wireless power when coupled to a power-transmit unit via a magnetic field, the power-receive unit including:
a coil configured to generate an electric current when exposed to the magnetic field;
an electrical component providing an impedance when a voltage or the electric current is applied to the electrical component;
a timer configured to define one or more frequencies for the electrical component; and
an electrical switch connecting the electrical component to the timer; and
an input mechanism connected to the electrical switch and configured, when actuated, to close the electrical switch to enable the electric current to flow through both the electrical component and the timer and cause an impedance shift at the coil based on the impedance of the electrical component according to the one or more frequencies defined by the timer, the one or more frequencies being detectable by the power-transmit unit to trigger a function.

2. The wirelessly powered remote switch of claim 1, further comprising:
a plurality of electrical components comprising at least a first electrical component and a second electrical component; and
a plurality of timers comprising at least a first timer and a second timer.

3. The wirelessly powered remote switch of claim 2, wherein:
the first electrical component is connected to the first timer via a first electrical switch;
the second electrical component is connected to the second timer via a second electrical switch;
the first electrical component provides a first impedance and the second electrical component provides a second impedance; and
the first timer provides a first frequency and the second timer provides a second frequency.

4. The wirelessly powered remote switch of claim 3, wherein:
the first impedance is the same as the second impedance; and
the first frequency is different from the second frequency.

5. The wirelessly powered remote switch of claim 3, wherein:
the first impedance is different from the second impedance; and
the first frequency is different from the second frequency.

6. The wirelessly powered remote switch of claim 2, wherein:
the first electrical component is connected to the first timer via a first electrical switch;
the second electrical component is connected to the first timer via a second electrical switch; and
the first electrical component provides a first impedance and the second electrical component provides a second impedance.

7. The wirelessly powered remote switch of claim 6, wherein:
the first timer includes logic that sets the one or more frequencies based on a closed switch; and
the first timer defining a first frequency when the first electrical switch is closed, a second frequency when the second electrical switch is closed, and a third frequency when the first and second electrical switches are closed simultaneously.

8. The wirelessly powered remote switch of claim 1, further comprising an impedance matching network configured to match the impedance of at least the electrical component.

9. The wirelessly powered remote switch of claim 1, further comprising a rectifier configured to convert the electric current generated by the coil from an alternating current signal to a direct current signal and provide the direct current signal to the electrical component.

10. The wirelessly powered remote switch of claim 1, wherein the timer is latched for a predefined duration of time.

11. The wireless powered remote switch of claim 1, wherein the function is a function of an electrical system connected to the power-transmit unit.

12. The wireless powered remote switch of claim 1, wherein the magnetic field is a constant field.

13. The wireless powered remote switch of claim 1, wherein the magnetic field is an event-driven field.

14. The wireless powered remote switch of claim 1, wherein the magnetic field is a polled field.

15. A method comprising:
detecting a localized field disturbance in a magnetic field generated by a power-transmit unit of a wireless-power-transfer system that is coupled to a power-receive unit of the wireless-power-transfer system for transferring power from the power-transmit unit to the power-receive unit;
measuring one or more frequency components associated with the localized field disturbance;
determining, based on the one or more frequency components, that at least one input mechanism has been actuated at the power-receive unit; and
initiating, by the power-transmit unit, a function associated with actuation of the at least one input mechanism at the power-receive unit.

16. The method of claim 15, further comprising identifying, based on the one or more frequency components, the at least one input mechanism from a plurality of input mechanisms at the power-receive unit each associated with a respective frequency.

17. The method of claim 15, wherein measuring the one or more frequency components associated with the localized field disturbance includes using Fourier analysis on one or more sensors of the power-transmit unit to determine the one or more frequency components.

18. The method of claim 15, wherein measuring the one or more frequency components includes measuring the one or more frequency components of a magnitude or a phase of an electric current associated with an impedance change detected at the power-transmit unit.

19. The method of claim 15, wherein measuring the one or more frequency components includes measuring the one or more frequency components of a magnitude or a phase of a voltage corresponding to an impedance change detected at the power-transmit unit.

20. The method of claim 15, wherein measuring the one or more frequency components includes measuring the one or more frequency components of a magnitude or a phase of a proximal field associated with an impedance change detected at the power-transmit unit.
